(19) United States
(12) Patent Application Publication
(10) Pub. No.: US 2005/0189279 A1
(43) Pub. Date: Sep. 1, 2005

(54) Stationary phase for liquid chromatography using chemically modified diamond surfaces

(76) Inventors: Jishou Xu, Irvine, CA (US); Edmond Bowden, Raleigh, NC (US)

Correspondence Address: JUSHOU XU, 15 HEARTHSTONE, IRVINE, CA, 92606, US

(21) Appl. No.: 11/068,628

(22) Filed: Mar. 1, 2005

Related U.S. Application Data
(63) Continuation of application No. 10/322,863, filed on Dec. 18, 2002, now abandoned.

(51) Int. Cl. B01D 15/08

(52) U.S. Cl. 210/198.2; 210/656; 423/446; 423/415.1; 423/414

(57) ABSTRACT

Hydrophilic diamond surfaces comprise surface oxygen bonded onto diamond surface only through oxygen/carbon single bond. The hydrophilic diamond surfaces are treated with strong reductant (e.g., lithium aluminum hydride) to reduce oxygen/carbon double bonds to oxygen/carbon single bond. The hydrophilic diamond surfaces can be used as stationary phase for liquid chromatography.

### REFERENCES

US Patents

U.S. Pat. No. 5,593,783 Miller

U.S. Pat. No. 6,372,002 D'Evelyn

U.S. Pat. No. 6,406,776 D'Evelyn

Liquid Chromatography:

1. Stella, C.; Rudaz, S.; Veuthey, J.; Tchapla, A. “Silica and Other Materials as Supports in LC. Chromatographic Test and Their Important for Evaluating These Supports” Chromatographia, 2001, 53, 113.

2. Dunlap, C. J.; McNeff, C. V.; Stoll, D.; Carr, P. W. “Zirconia Stationary Phases for Extreme Separations” Anal. Chem., 2001, 73, 598A.

3. Barber, T. J.; Wohlman, P. J.; Thrall, C.; Dubois, P. D. “Fast Chromatography and Nonporous Silica” LC-GC, 1997, 15, 918.

4. Bassler, B. J.; Hartwick, R. A. “The Application of Porous Graphitic Carbon as an HPLC Stationary Phase” J. Chromatogr. Sci., 1989, 27, 162.

5. Leonard, M.; “New Packing Materials for Protein Chromatography” J. Chromatogr. B, 1997, 699, 3.

Surface Modification of Diamond

6. Raymond, F. C.; “Admantane: The Chemistry of Diamond Molecules” New York: Dekker, 1976.

7. Buriak, J. M. “Diamond Surfaces: Just Big Organic Molecules” Angew. Chem. Int. Ed., 2001, 40, 532.

8. Wang G., Bent S., “Functionalization of Diamond(100) by Diels-Alder Chemistry” J. Am. Chem. Soc., 2000, 122, 744.

9. Hovis, J.; Coulter, S.; Hamers, R.; D'Evelyn, M.; Russell, J.; Butler, J. “Cycladdition Chemistry at Surfaces: Reaction of Alkenes with the Diamond (001)-2×1 Surface” J. Am. Chem. Soc., 2000, 122, 732.

This application is a division of U.S. patent application Ser. No. 10/322,863, filed on Dec. 18, 2002, titled “Packing Materials for Liquid Chromatography Using Chemically Modified Diamond Powders” with inventor Jishou Xu and Edmond Bowden.

The present invention relates to stationary phases useful in applications such as separation, purification and extraction of proteins, peptides, etc., as well as processes for producing such stationary phases. The stationary phase will have extremely high stability and little non-specific interaction.

### BACKGROUND OF THE INVENTION

In the field of liquid chromatography (LC), there has been continuous demand for stationary phases with high chemical stability and little non-specific interaction. Stationary phases with high chemical stability and little non-specific interaction are specifically precious for LC of proteins. First, LC of proteins suffers more from the non-specific interaction than LC of small molecules. Non-specific interaction leads to severe peak tailing or even low recovery for protein separation. Second, protein samples often foul LC columns because some protein components are irreversibly retained. The proteins retained on LC columns are difficult to be flushed away by merely adjusting the hydrophobicity of the flush solution. Cleaning under high pH is an efficient way to flush away various proteins but at the risk of damaging LC columns. If a column is stable at pH>14, flushing the fouled column at pH>14 will decompose retained proteins into amino acids and the foulants will then be rinsed away readily.

Porous packing materials are generally preferred to non-porous packing materials in LC of small molecules. Non-porous packing materials have adsorption capacities lower than the porous sorbents. On the other hand, non-porous packing materials have shorter diffusion paths, which minimizes the peak broadening by mass transfer resistance. Non-porous particles have gained increasing interest for LC of proteins. Particles designed for LC of proteins often have large pore sizes. For a particle with large pore size, the loading capacity has been found to be only a few times higher than that of equally sized non-porous packing materials. At the same time, the improvement of column efficiency of non-porous particles becomes much more significant for the separation of proteins. For large molecules, non-porous packing materials exhibit fast mass transport as restricted pore diffusion is eliminated and peak broadening is significantly minimized.

Packing materials are best with spherical shape and with uniform distribution of size. Imperfections of particle shape and size distribution are more tolerable in HPLC of proteins because gradient elution is always applied. Imperfections of particle shape and size distribution are not much detrimental for packing materials used in solid phase extraction, zip-tipping, and the first dimension LC in two-dimensional LC.

### DESCRIPTION OF THE PRIOR ART

The commonest packing material for LC has been chemically modified silica powders. Silica columns suffer from low stability under high pH and non-specific interaction. The low stability of silica packing materials is due to the dissolution of silica and the hydrolysis of the surface bonds between the surface capping and silica. For reverse phase silica, non-specific interaction arises from residual surface hydroxyl groups. Silica surfaces are stably capped by hydroxyl groups, which are hydrophilic and negatively charged at pH>4.

Graphitic packings and polymeric packings can be much more stable than silica packing materials. The bulk of graphite and many polymers is stable under a broad range of pH. The surface bonds for graphitic packings and polymeric packings (e.g., C—C bonds) can be also stable under a broad range of pH. Unfortunately, graphitic packings and polymeric packings often suffer from non-specific interaction more than silica packings. There are an undefined amount of basal plane sites on graphitic surfaces, which can not be chemically derivatized directly. Strong non-specific interaction resulted from basal plane sites has been evidenced in graphitic packings. The conjugated π-electrons contribute to the surface interaction at graphitic surfaces. For polymeric packings, the non-specific interaction is due to the facts that: i) polymeric packing materials usually contain aromatic structures; and ii) polymers are usually neither fully dense nor rigid at molecular scales. The organic matrix (specifically aromatic components) of polymers participates in non-specific interaction. Polymeric solids contain some voids with sizes ranging from atomic scales to nano-scales. The adsorption at polymer is a combination of surface process and “hole filling” process. Polymeric surfaces are not rigid or immobile as the surfaces on atomic or ionic crystals. Surface dynamics permit the polymeric lattice to reconstruct in response to the adsorbates. Such surface dynamics are an important factor to promote adsorption at polymeric surfaces.

The preparation of diamond powders with sizes from 200 nanometers to 100 micrometers has been relatively cheap and large volume technology. Unmodified diamond powders have been used as packing material for HPLC. Unmodified diamond powders both occurred naturally and manufactured are capped with a mixture of hydrogen, which is hydrophobic, and oxygen functionalities, many of which are hydrophilic or charged. Hence, the unmodified diamond powders are not of high quality neither as normal phase packing materials nor as reverse phase packing materials. It is necessary to chemically modify diamond powders to make them capped with the desired capping. To minimize non-specific interaction, the residual groups on diamond surfaces should be well controlled, too. Diamond surfaces can be stably capped by both hydrogen and hydroxyl. A totally hydrophobic diamond surface can be prepared with hydrophobic hydrogen atoms as residual groups, and a totally hydrophilic diamond surface can be prepared with hydrophilic hydroxyl groups as residual groups.

Recent studies on the surface chemistry of diamond have shown that diamond surfaces are chemically modifiable. First, chemically, diamond is a giant polycyclic aliphatic molecule and the diamond surface is composed of organic functionalities, for which an enormous database of methods and mechanisms has been established. The chemical composition of diamond surfaces can be finely controlled through organic reactions. Second, because of the chemical inertness of the bulk of diamond (i.e., tetrahedral C—C bonds), even surface functionalities with low reactivity (e.g., tetrahedral C—H bonds) can be modified under violent conditions with little damage to the bulk of diamond. Diamond surfaces were hydrogenated by hydrogen plasma or under temperatures >800 Celsius degree. Halogenation of diamond surfaces has been carried out with plasma and under UV radiation. Chlorinated diamond surfaces are active in reactions with water, ammonia, etc. Organic groups have been attached onto halogenated diamond surfaces through stable surface bonds (e.g., C—N and C—C single bonds). Organic groups can also be attached onto diamond surfaces through C—C surface bonds by cycloaddition reactions. The organic groups attached onto diamond surfaces can be further modified under various conditions with little damage to the bulk of diamond.

### BRIEF DESCRIPTION OF THE INVENTION

The present invention sets forth methods to prepare stationary phases with extremely high stability and little non-specific interaction. The stationary phases are based on chemically modified diamond surfaces. The chemical modification will control the surface chemistry of diamond surfaces. For normal phase stationary phases, the surface termination will be hydrophilic hydroxyl groups.

For the stationary phases based on chemically modified diamond surfaces, there will be not any chemical degradation arising from the bulk of diamond or the surface bonds between diamond and the organic groups under any condition that is applied for LC. The chemically modified diamond surfaces will be stable in any basic solutions, which allows regeneration and cleaning procedures for LC columns at pH>14. In LC of proteins, LC columns are often fouled by protein components irreversibly retained. The retained protein components are difficult to be flushed away by merely adjusting the hydrophobicity of the flush solution. Flushing the fouled columns at pH>14 will decompose retained proteins into amino acids and the foulants will then be rinsed away readily.

For the stationary phases based on chemically modified diamond surfaces, the non-specific interaction is largely eliminated. Hydroxyl groups on diamond surfaces will not be deprotonated in aqueous solution as silanols. Diamond is fully dense and rigid at the atomic scale. Diamond stationary phases are free of the non-specific interaction associated with polymeric packings. Diamond is isotropic. The surface sites at different crystal faces and defect sites on diamond surfaces are all active to coupling reactions. Diamond is composed of tetrahedral carbon. Diamond stationary phases will be free of the non-specific interaction associated with graphitic stationary phases.

The stationary phases based on chemically modified diamond surfaces can be also used in solid phase extraction, zip-tipping, and the first dimension LC for two-dimensional LC. For these applications, stationary phases based on chemically modified diamond surfaces will have their advantages in stability, anti-fouling ability, de-fouling capability, and high recovery without the disadvantages resulted from the imperfections of particle shape and size distribution.

Oxygen terminated diamond surfaces have been prepared under violent oxidation conditions (e.g., oxygen plasma, boiling in aqua regia, or electrochemical polarization). The surface composition for the oxygen terminated diamond prepared by oxygen plasma, boiling in aqua regia, or electrochemical polarization is not well-controlled and most likely results in a mixture of oxygen functionalities (e.g., OH, carbonyl, and —COOH). The presence of carbonyl and —COOH groups will introduce non-specific interactions when such oxygen terminated diamond powders are used as stationary phase for LC. Specifically, the —COOH groups, which are readily deprotonated, will present strong non-specific interactions.

### SUMMARY OF THE INVENTION

Exemplary processes for the preparation of stationary phases based on chemically modified diamond surfaces will now be discussed. The process begins with diamond materials that are commercially available, whose surfaces are typically capped by a mixture of hydrogen and oxygen functionalities. Diamond materials comprise diamond powders that occur naturally in nature, diamond powders that are manufactured, and diamond coatings that are manufactured. The size of diamond powders can be, for example, but not limited to, 1-50 micrometers.

Step 1: Oxygenation of Diamond Surfaces

To introduce oxygen atoms onto the diamond surfaces, the as-received diamond materials will be boiled in corrosive solutions with strong oxidants (e.g., aqua regia).

Alternatively, the as-received diamond materials will be performed with halogenation followed by hydrolysis. The halogenation process can be performed with, for example, but not limited to, chlorine. The halogen atmosphere for halogenation can contain the halogen with an inert gas. The inert gas can be, for example, but not limited to, helium. The halogenation process can be activated by, for example, but not limited to, UV light, plasma, or heating. The temperature for halogenation can be, for example, but not limited to, 200 to 400 Celsius degree. The halogen atmosphere can be continuously flowing through the reactor. The halogenated diamond surfaces will be hydrolyzed with basic solution. pH of the hydrolysis solution can be adjusted with, for example, but not limited to, sodium bicarbonate or sodium hydroxide. To transform more surface hydrogen termination into surface oxygen termination, these diamond surfaces can be performed with two or more cycles of halogenation followed by hydrolysis. Alternatively, the diamond surfaces will be performed with multiple cycles of halogenation by flowing halogen gas through the reactor followed by hydrolysis by flowing water moisture through the reactor.

Step 2: Reduction of Oxygenated Diamond Surfaces

The diamond surfaces will then be reduced with strong reducing agent. The strong reducing agent can be, for example, but not limited to, lithium aluminum hydride. The strong reducing agent hydride will be initially dissolved in organic solvent. The organic solvent can be, for example, but not limited to, tetrahydrofuran. Almost all surface oxygen functionalites other than hydroxyl will be reduced to hydroxyl by the strong reducing agent.

1. Diamond materials comprising oxygen terminated diamond surfaces free of surface carbon/oxygen double bonds.

2. A method for preparing hydrophilic diamond surfaces, comprising the steps of, in sequence,
i) exposing the diamond surfaces to strong oxidants, thereby forming surface carbon/oxygen bonds on the diamond surfaces,
ii) exposing the diamond surfaces to a reducing agent, thereby transforming the surface functionalities containing carbon/oxygen double bonds on the diamond surfaces into hydroxyl groups.

3. A method for preparing hydrophilic diamond surfaces as claimed in claim 2, wherein the surface carbon/oxygen bonds will be formed by the steps of, in sequence,
i) exposing the diamond surfaces to halogenating agents, thereby replacing some hydrogen atoms on the diamond surfaces with halogen atoms,
ii) exposing the diamond surfaces to a basic aqueous solution or water moisture, thereby replacing the halogen atoms on the diamond surfaces with oxygen atoms,
iii) repeating procedure (i) and (ii) for one or more times,
iv) exposing the diamond surfaces to a reducing agent, thereby transforming the surface functionalities containing carbon/oxygen double bonds on the diamond surfaces into hydroxyl groups.

4. A method for preparing hydrophilic diamond surfaces as claimed in claim 2, wherein the surface carbon/oxygen bonds will be formed by the steps of, in sequence,
i) exposing the diamond surfaces to hot aqua regia, thereby forming surface carbon/oxygen bonds on the diamond surfaces with halogen atoms
ii) exposing the diamond surfaces with a reducing agent, thereby transforming the surface functionalities containing carbon/oxygen double bonds on the diamond surfaces into hydroxyl groups.
